(19) United States
(12) Patent Application Publication
(10) Pub. No.: US 2009/0146778 A1
(43) Pub. Date: Jun. 11, 2009

(54) SYSTEM COMPRISING AN OBJECT AND A SENSING UNIT FOR IDENTIFYING THE OBJECT

(75) Inventor: Wilhelmus Franciscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,562

(22) PCT Filed: Nov. 21, 2005
(86) PCT No.: PCT/IB05/53837

§ 371 Date: May 17, 2007

(30) Foreign Application Priority Data
Nov. 23, 2004 (EP) 04105996.5

(51) Int. Cl. G05B 19/00

(52) U.S. Cl. 340/5.8

(57) ABSTRACT

The invention relates to a system (Sy) which comprises an object (01) and a sensing unit (SU) for identifying the object (O1). The object (O1) comprises a generator (T1, T2) for generating first and second fields (F1, F2), a ratio of whose respective strengths has a predetermined value. The sensing unit (SU) is operative to identify the object (O1) on the basis of the predetermined value. The invention farther relates to an arrangement of sensing units for use in the system of the invention.

### FIELD OF THE INVENTION

The invention relates to a system comprising an object and a sensing unit.

The invention further relates to an object, a set of objects, a sensing unit, a control device comprising the system, and an electronic device comprising the control device.

### BACKGROUND OF THE INVENTION

A game which recognizes objects is disclosed in DE 3309817. This game has a playing area consisting of a plurality of playing fields and a plurality of playing pieces. Each playing piece has a coded element. Each plurality of playing fields has a sensor which is able to detect a code from the coded element within its field. The outputs of the sensors are connected to a signal-processing device via which the course of the game is stored and/or evaluated. In the described embodiment, each plurality of playing fields has a Hall sensor and each plurality of playing pieces has a permanent magnet being the coded element. The code is represented by a predefined length of the permanent magnet, which results in a predefined magnetic field strength sensed by the Hall sensor. The playing pieces are captured through detection of the magnetic field strength resulting from the permanent magnet inside each playing piece.

In the game as disclosed in the prior-art document, the playing piece must be positioned very accurately and reproducibly with respect to the Hall sensor so as to identify the playing piece from the sensed magnetic field.

### OBJECT AND SUMMARY OF THE INVENTION

It is an object of the invention to provide a system comprising an object interacting with a sensing unit, wherein the position of the object with respect to the sensing unit is less critical.

According to the invention, this object is realized in that the system comprises an object which comprises a generator for generating first and second fields, a ratio of whose respective strengths has a predetermined value, and a sensing unit which is operative to identify the object on the basis of the predetermined value. In contrast, the prior-art playing piece, also referred to as pawn, only comprises a single magnet generating a single field. Advantageously, the system is less sensitive to environmental disturbances, for example, the stray earth's magnetic field. Proportional disturbances which are equally present in both signals are reduced. The object may be, for example, a playing piece used in a game or may be attachable to a playing piece.

The sensing unit may comprise a first field sensor for sensing a first field and a second field sensor for sensing a second field, and is operative to determine an identifier of an object on the basis of the ratio between the first sensed field and the second sensed field.

The sensing unit may comprise a sensing plane comprising a sensing surface having a plurality of field sensors for supplying a plurality of sensed signals each being representative of a sensed field at respective locations of each one of the plurality of field sensors, a processor for receiving the sensed signals to determine a first processor signal being dependent on at least one of the sensed signals and a second processor signal being dependent on at least another one of the sensed signals and for dividing the first processor signal and the second processor signal to obtain an output signal, wherein the first processor signal and the second processor signal are selected to vary with the same power of a distance between the object and the field sensors when the position of the object is changed with respect to the sensing surface for changing said distance, and a comparator for comparing the output signal with a predetermined value to supply an identification signal identifying the object. In a game, the sensing surfaces may correspond to the playing fields and the sensing plane may correspond to the playing area of the prior-art DE 3309817.

The sensed fields, sensed by the field sensors are dependent on a strength of the fields which are generated by each field generator of the object, and on the distance of the object with respect to the field sensors. At a first position of the object with respect to the sensing surface, the combination of the strength of the fields generated by the object and the distance between the first position and the field sensors results in a first set of sensed signals. The processor receives this first set of sensed signals and determines a first processor signal which is dependent on at least one of the sensed signals of the first set of sensed signals. Furthermore, the processor determines a second processor signal which is dependent on at least another one of the sensed signals of the first set of sensed signals. In addition, the processor divides the first processor signal by the second processor signal to obtain the output signal. As the first processor signal and the second processor signal are selected to vary with the same power of the distance between the object and the field sensors, when dividing the first processor signal by the second processor signal, the dependency of the output signal on the distance between the object and the field sensors is strongly reduced.

However, the output signal is still dependent on the strength of the fields which are generated by each field generator of the object, in that different objects using different field strength ratios can be identified. To identify the object, the output signal is compared with a predetermined value at the comparator. Thus, if the same object is moved to change the first distance into a second distance from the field sensors, the sensors supply a second set of sensed signals. For example, if the second distance is half the first distance, the level of each sensed signal of the second set is eight times the level of each corresponding one of the sensed signals at the first distance. The processor again converts these sensed signals into the first processor signal and the second processor signal, which are divided to obtain a second output signal. Due to the division, the dependency on the distance has hardly any influence, and the second output signal is (almost) equal to the first output signal. Consequently, the reduced dependency of the output signal of the processor on the distance between the object and the sensing surface strongly reduces the variation of the output signal and allows a more reliable identification of the object.

In the prior art, a playing piece, further also referred to as pawn, comprises a single permanent magnet which generates a single magnetic field. The detection of this magnetic field by a Hall sensor is strongly dependent on the distance between the Hall sensor and the permanent magnet. Therefore, changing the distance between the permanent magnet and the Hall sensor may possibly result in a faulty identification of the playing piece. Due to the division, the variation of the output signal which is used to identify the object is less critical with respect to the distance between the object and the sensing surface in the system according to the invention. This strongly reduces possible faulty identification of objects which, due to changes of the distance, produce different fields at the particular same distance from the sensing surface.

In an embodiment of the system, a field generator distance between adjacent ones of the field generators of the same one of the objects and a sensor distance between corresponding field sensors of the sensing surface are selected in such a way that each field generator is positionally correlated with an associated one of the field sensors. For example, in an embodiment, the object comprises two field generators and the sensing surface comprises two sensors supplying a first sensed signal and a second sensed signal. Thus, both sensed signals mainly result from a corresponding single one of the field generators. This embodiment has the advantage that the reduction of dependency on the distance can already be achieved by simply dividing the first sensed signal by the second sensed signal. An additional advantage is that the presence of an object at a specific one of the sensing surfaces can directly be determined from the output signal of the processor. This additional advantage is obtained because only the field sensors to which a field generator corresponds supply a sensed signal to the processor, and thus the presence of an output signal indicates the presence of the object.

The sensing unit may further comprise a third field sensor for sensing a third field, and is further operative to correct the ratio between the first sensed field and the second sensed field on the basis of the third sensed field. Advantageously, this makes the system less sensitive to variations of orientation/placement of the object.

The system may comprise further sensing units in a predetermined spatial arrangement, each respective one of the units being operative to identify the object on the basis of the predetermined value. Advantageously, a system that has more than one sensing surface is able to indicate at which surface the object is located.

The system may comprise a further object, the further object comprising a further generator for generating a further first field and a further second field, a ratio of whose respective further strengths has a further predetermined value, the predetermined value and the further predetermined value being different from one another. The field generators are arranged to obtain for different objects, if positioned at the same position with respect to the sensing surface, different sensed signals which have different values at the same one of the field sensors. The different sensed signal may result, for example, from a difference in the distance between a field sensor and at least one of the field generators of two different objects, wherein a base of the objects has the same distance with respect to the sensing surface. Usually, the base of an object is identical to the contact surface with the sensing surface if the object is placed on the sensing surface. The different sensed signal may also, for example, result from a difference in field strength of corresponding ones of the field generators in different objects. This has the advantage that the system is able to identify different objects.

The object may comprise means for altering a field strength or orientation of at least one of the generated fields. In one embodiment, the field generators are, for example, permanent magnets and the object comprises mechanical arrangements which, for example, allow an exchange of a first field generator, which generates a first field, for a second field generator, which generates a second, different field. The second field generator generates, for example, a field which has a larger field strength, or, for example, a field which has a different field orientation. In another embodiment, at least one of the field generators is, for example, an inductance and the object comprises an electronic circuit which may alter the current through the inductance. This changes the field which is produced by the inductor. The same construction of the object can thus be used to generate different sets of fields per object allowing identification of that one of the different objects which is actually used. The object may comprise means for altering a position of at least one of the at least two field generators relative to the other field generator or field generators. The object comprises, for example, at least one cylindrical tube, which comprises one of the field generators and wherein this field generator can be fixed at several predefined positions. This cylindrical tube enables one of the at least two field generators to be moved, for example, away from or closer to a base of the pawn and thus away from or closer to the sensing surface. This change of the relative position of at least one of the at least two field generators results in a change of the sensed signals. The resultant change of the output signal of the processor is used to recognize the pawn.

The generator may be arranged to generate magnetic fields. Magnetic field generators can be manufactured at relatively low cost. Alternatively, the generator may be arranged to generate acoustic, electromagnetic, electric or visual fields.

A second aspect of the invention provides a control device which comprises the system of the invention and further comprises a control unit operative to receive an identifier identifying the object from the sensing unit and to control an electronic device in response to the identifier. The control device can thus be used as a universal user interface device for different electronic devices. In an embodiment of the control device, a sensing surface comprises an image which represents information. The control unit is arranged to indicate an action to be performed by the electronic device when the object is detected via the sensing surface. The image is, for example, a pictogram which represents an action to be performed by the electronic device, like “record”, or “play”, etc. Alternatively, the image may be a picture which represents a room in a house, like a “bathroom”, a “bedroom”, etc. Alternatively or additionally, the object itself may represent information. The object may represent, for example, an electronic device, like a Digital Video Disk player or a Television set. The control device may comprise, for example, several objects each representing an electronic device. The sensing unit may comprise, for example, several sensing surfaces each comprising the pictogram which represents the action to be performed by the electronic device. When a user selects the object representing the electronic device which he wants to control and when he places the object at the sensing surface which comprises the pictogram representing the action “play”, the control device sends a signal to the selected electronic device to indicate the action required.

A third aspect of the invention provides an electronic device which comprises the control device of the invention.

These and other aspects of the invention are apparent from and will be elucidated with reference to the embodiments described hereinafter.

### BRIEF DESCRIPTION OF THE DRAWINGS

In the drawings,

FIG. 1A shows a conceptual diagram of an embodiment of the system according to the invention,

FIG. 1B shows the conceptual diagram wherein a first object is replaced by a second object,

FIG. 1C shows the conceptual diagram wherein the distance between the first object and the field sensors is changed into a new distance,

FIG. 1D shows the conceptual diagram wherein the position of one of the field generators inside the first object is displaced,

FIG. 1E shows the conceptual diagram wherein the sensing plane comprises a second sensing surface,

FIG. 1F shows the conceptual diagram wherein the sensing surface comprises a third sensor,

FIG. 1G shows the conceptual diagram wherein the sensed signal from a field sensor mainly results from a single field generator,

FIG. 2 shows an implementation of the system when applied to a game,

FIG. 3 shows an implementation of the system when applied to a control device for lighting control, and

FIG. 4 shows an implementation of the system when applied to a consumer electronics device.

### DESCRIPTION OF EMBODIMENTS

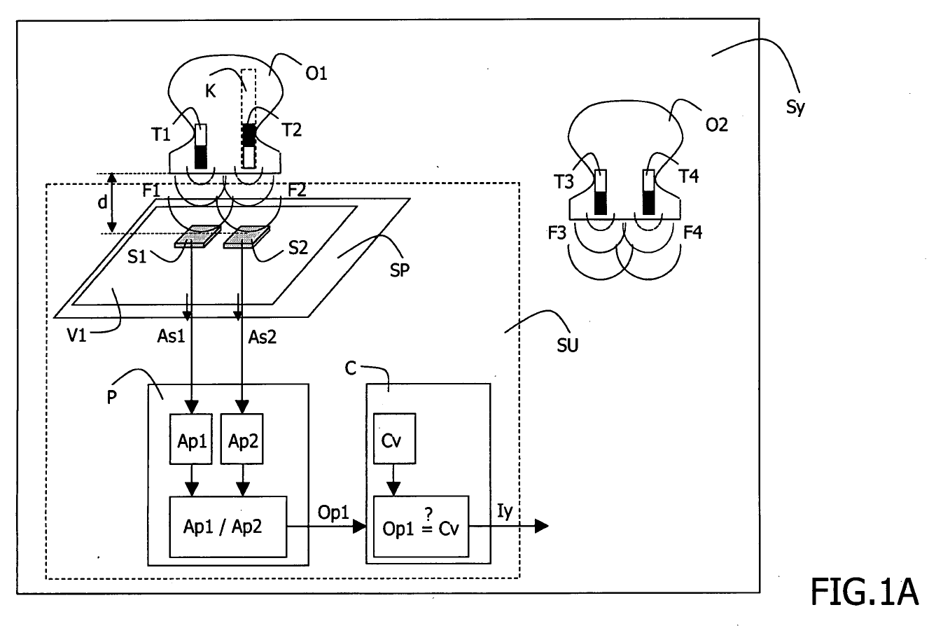

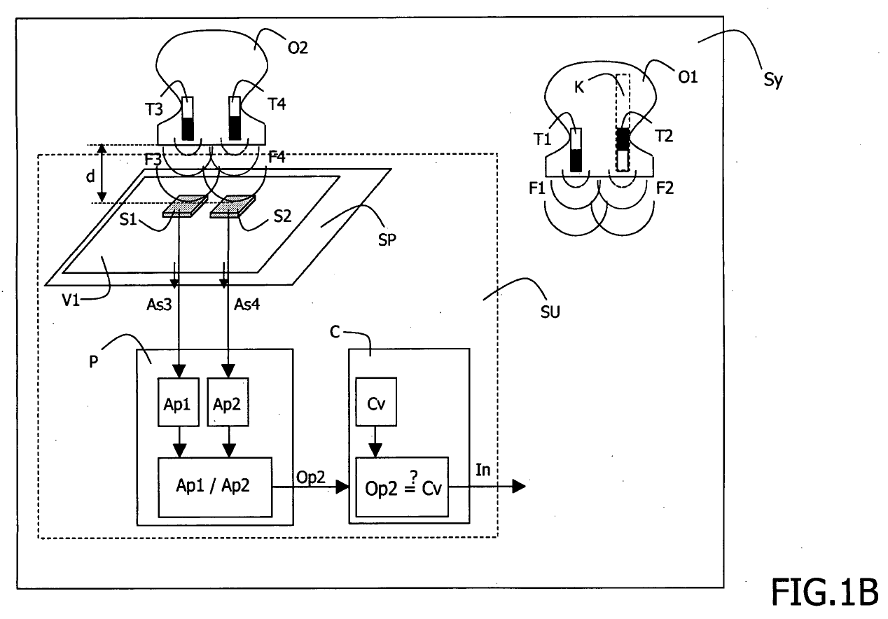

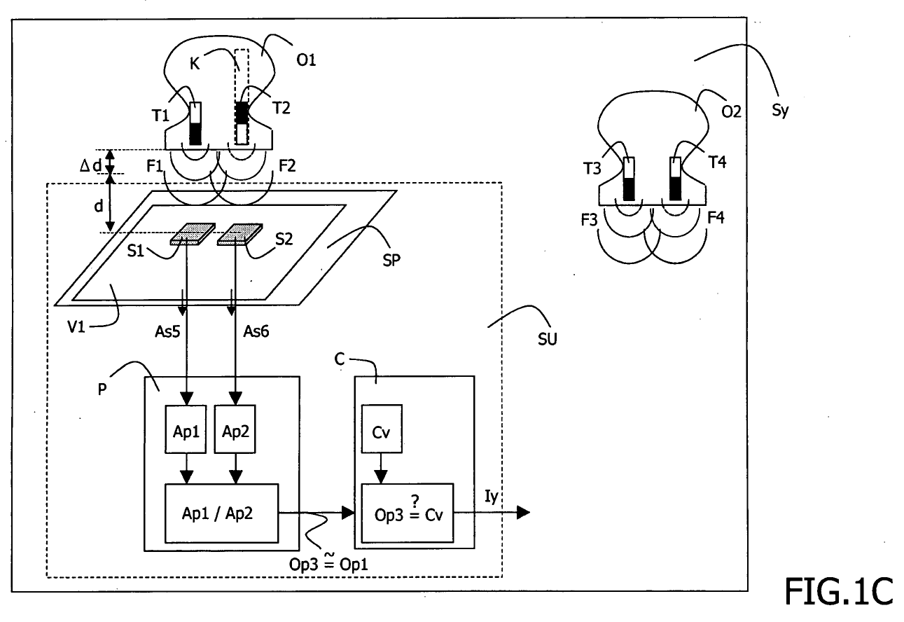

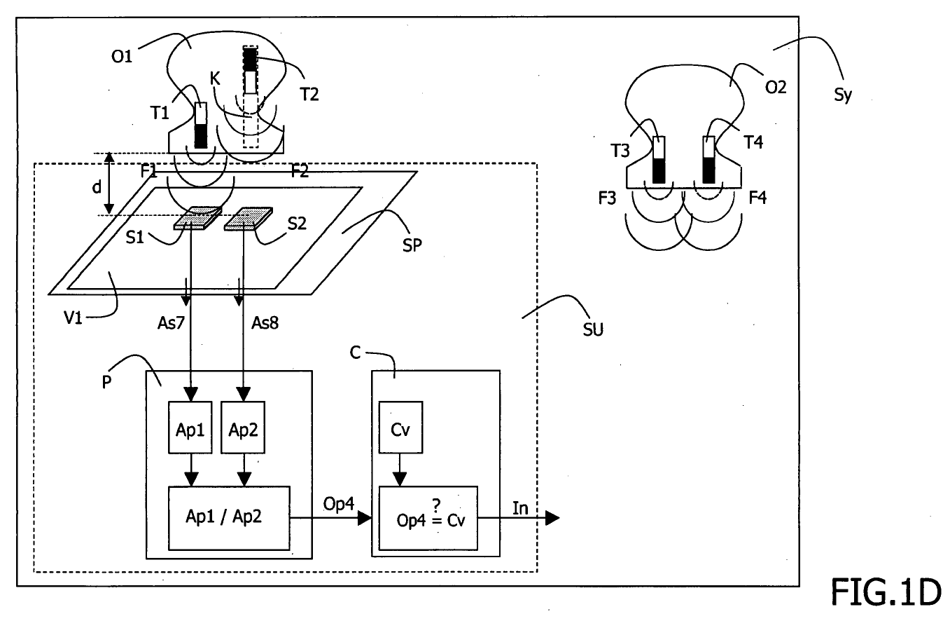

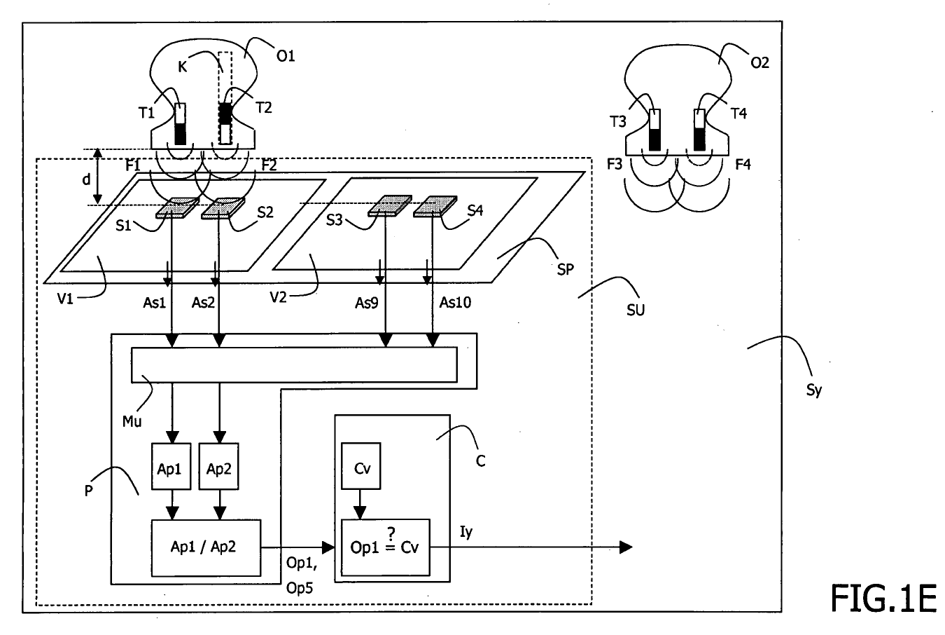

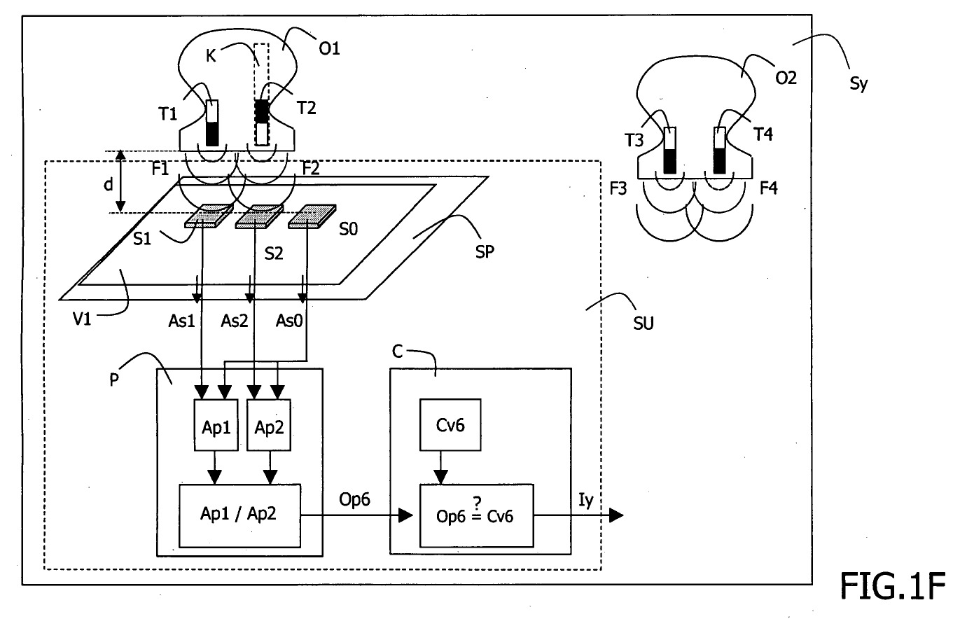

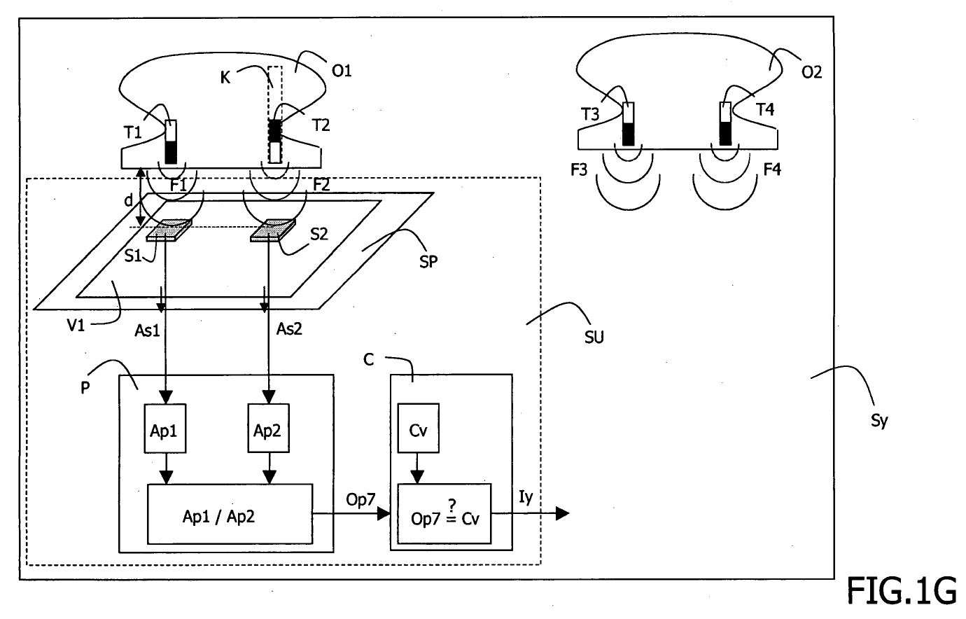

FIG. 1A shows a conceptual diagram of an embodiment of the system Sy according to the invention. The system Sy comprises two objects, a first object O1 and a second object O2 both of which comprise two field generators T1, T2; T3, T4, respectively. Each field generator T1, T2; T3, T4 generates a field F1, F2, F3, F4, respectively. The system further comprises a sensing unit SU which comprises a sensing plane SP having a sensing surface V1. In FIG. 1A, the first object O1 is positioned at a distance d with respect to a sensing surface V1. The sensing surface V1 comprises a first field sensor S1 which supplies a first sensed signal As1. The sensing surface V1 further comprises a second field sensor S2 which supplies a second sensed signal As2. Each sensed signal As1, As2 represents the sensed field at the respective locations of the field sensors S1, S2. The sensing unit SU further comprises a processor P which receives the sensed signals As1, As2 and generates a first processor signal Ap1 and a second processor signal Ap2. In FIG. 1A, the first processor signal Ap1 is dependent on the first sensed signal As1 and the second processor signal Ap2 is dependent on the second sensed signal As2. The processor P further divides the first processor signal Ap1 by the second processor signal Ap2 to obtain a first output signal Op1. The sensing unit SU also comprises a comparator C which receives the first output signal Op1 from the processor P and comprises a predetermined value Cv. The comparator C compares the first output signal Op1 from the processor P with the predetermined value Cv and generates an identification signal Iy.

The first processor signal Ap1 and the second processor signal Ap2 are selected to vary with the same power of the distance d when the position of the object O1 is changed with respect to the sensing surface V1. In the configuration shown in FIG. 1A, the first processor signal Ap1 is dependent on the first sensed signal As1 and the second processor signal Ap2 is dependent on the second sensed signal As2. For example, the first processor signal Ap1 and the second processor signal Ap2 are linearly proportional with the first sensed signal As1 and the second sensed signal As2, respectively. Alternatively, the first processor signal Ap1 and the second processor signal Ap2 may be different linear combinations of the first sensed signal As1 and the second sensed signal As2. What counts is that the dependency of the first processor signal Ap1 and the second processor signal Ap2 on a variation of the distance d is identical or almost identical. When dividing the first processor signal Ap1 by the second processor signal Ap2 to generate the output signal Op1, the dependency of the output signal on the distance d is strongly reduced.

FIG. 1B shows the conceptual diagram wherein a first object O1 is replaced by the second object O2. The second object O2 comprises two field generators T3, T4 each generating a field F3, F4. The fields F3, F4 generated by the second object O2 are different from the fields F1, F2 generated by the first object O1. In FIG. 1B, the second object O2 is located at the same position (at the same distance d) with respect to the sensing surface as the first object O1 in FIG. 1A. Due to the different fields F3, F4 generated by the second object O2, the first field sensor S1 supplies a third sensed signal As3 which is different from the first sensed signal As1 (FIG. 1A). The second field sensor S2 supplies a fourth sensed signal As4 which is different from the second sensed signal As2 (FIG. 1A). Alternatively, only one of the sensed signals may be different. In this configuration, the processor P generates the first processor signal Ap1 being dependent on the third sensed signal As3 and the second processor signal Ap2 being dependent on the fourth sensed signal As4. The new output signal, indicated by second output signal Op2, results from dividing the first processor signal Ap1 (which results from the third sensed signal As3) by the second processor signal Ap2 (which results from the fourth sensed signal As4). This second output signal Op2 is applied to the comparator C. The comparator C compares the second output signal Op2 with the predetermined value Cv and generates an identification signal In. Since the second output signal Op2 is different from the first output signal (FIG. 1A), the identification signal In produced by the comparator when comparing the second output signal Op2 with the predetermined value Cv is also different. The identification of the different objects O1 and O2 improves if the sensor S1 predominantly receives the field F1 and the sensor S2 predominantly receives the field F2.

FIG. 1C shows the conceptual diagram wherein the distance d between the first object O1 and the field sensors S1, S2 is changed into a new distance d+Δd. In this Figure, the fields F1, F2 generated by the first object O1 are again sensed by the field sensors S1, S2 of the sensing surface V1. The new distance d+Δd between the first object O1 and the field sensors S1, S2 causes the first field sensor S1 to supply a fifth sensed signal As5 to the processor P and causes the second field sensor S2 to supply a sixth sensed signal As6 to the processor P. The first processor signal Ap1 which is generated by the processor P is dependent on the fifth sensed signal As5, and the second processor signal Ap2 which is generated by the processor P is dependent on the sixth sensed signal As6. A third output signal Op3 is generated by the processor P by dividing the first processor signal Ap1 (which results from the fifth sensed signal As5) by the second processor signal Ap2 (which results from the sixth sensed signal As6). When the first processor signal Ap1 is divided by the second processor signal Ap2, the dependency on the distance of each processor signal Ap1, Ap2 separately is strongly suppressed. Consequently, the third output signal Op3 is almost identical to the first output signal Op1. When the third output signal Op3 is compared with the predetermined value Cv, the identification signal Iy is equal to the identification signal Iy when the first output signal Op1 is compared with the predetermined value Cv (see FIG. 1A).

FIG. 1D shows the conceptual diagram wherein the position of one of the field generators T2 inside the first object O1 is displaced. In this Figure, the second field generator T2 inside the first object O1 is displaced. This displacement of the second field generator T2 causes the first field sensor S1 to supply a seventh sensed signal As7 and causes the second field sensor S2 to supply an eighth sensed signal As8. Processing the seventh sensed signal As7 and the eighth sensed signal As8 results in a fourth output signal Op4 which is different from the previous output signals. The reason is that dividing the first processor signal Ap1 by the second processor signal Ap2 only reduces dependencies on a change of distance when this change of distance is almost identical for both field generators T1, T2 with respect to the field sensors S1, S2. In the embodiment described in FIG. 1D, only the second field generator T2 is displaced and thus the fourth output signal Op4 supplied by the processor P is different from the first output signal Op1 (see FIG. 1A). When the fourth output signal Op4 is compared with the predetermined value Cv, the identification signal In is different from the identification signal from the first output signal Op1 (which is Iy, see FIG. 1A).

FIG. 1E shows the conceptual diagram wherein the sensing plane SP comprises a second sensing surface V2. To enable the processor P to generate a first processor signal Ap1 and a second processor signal Ap2 from each sensing surface V1, V2, the processor P comprises a multiplexer Mu to time-sequentially receive the first and second sensed signals As1 and As2, respectively, from the first sensing surface V1 and the ninth and tenth sensed signals As9 and As10, respectively, from the second sensing surface V2. The processor P therefore sequentially generates two output signals Op1, Op5 at the switching frequency of the multiplexer Mu, depending on which set of sensed signals is received. The comparator C now also sequentially generates two identification signals Iy, In at the switching frequency of the multiplexer Mu, depending on which output signal Op1, Op5 is received.

FIG. 1F shows the conceptual diagram wherein the sensing surface V1 comprises three sensors S0, S1 and S2. The first sensor S1 and the second sensor S2 again supply the first sensed signal As1 and the second sensed signal As2, respectively, to the processor P, as already explained with reference to FIG. 1A. In FIG. 1F, the processor receives an additional sensed signal As0 from the third field sensor S0. In FIG. 1F, the first processor signal Ap1 is, for example, dependent on a difference between the first sensed signal As1 and the additional sensed signal As0. The second processor signal Ap2 is, for example, dependent on a difference between the second sensed signal As2 and the additional sensed signal As0. A sixth output signal Op6 results from dividing the first processor signal Ap1 by the second processor signal Ap2. As the first processor signal Ap1 and the second processor signal Ap2 are defined differently in this Figure, the predetermined value with which the sixth output signal Op6 of the processor P is compared to identify the first object O1 also needs to be altered into a new predetermined value Cv6. Comparison of the sixth output signal Op6 with the new predetermined value Cv6 results in an identification signal Iy, which is identical to the identification signal from the first output signal Op1 (see FIG. 1A).

FIG. 1G shows the conceptual diagram wherein the sensed signal As1, As2 from each sensor S1, S2 mainly results for a single field generator F1, F2, respectively. Compared to the field generators F1, F2, F3, F4, the objects O1, O2 shown in this Figure are large. This allows the arrangement of the field sensors F1, F2 within the first object O1 to be such that the field of the first field generator F1 is sensed by the first sensor S1, and the field of the second field generator F2 is sensed by the second sensor S2. In other words, the field generator F2 has a much smaller field strength than the field generator F1 at the first sensor F1, and the field generator F1 has a much smaller field strength than the field generator F2 at the second sensor F2. This embodiment has the advantage that the sensed signals fully result from a single field generator, and an optimal identification of different objects is possible.

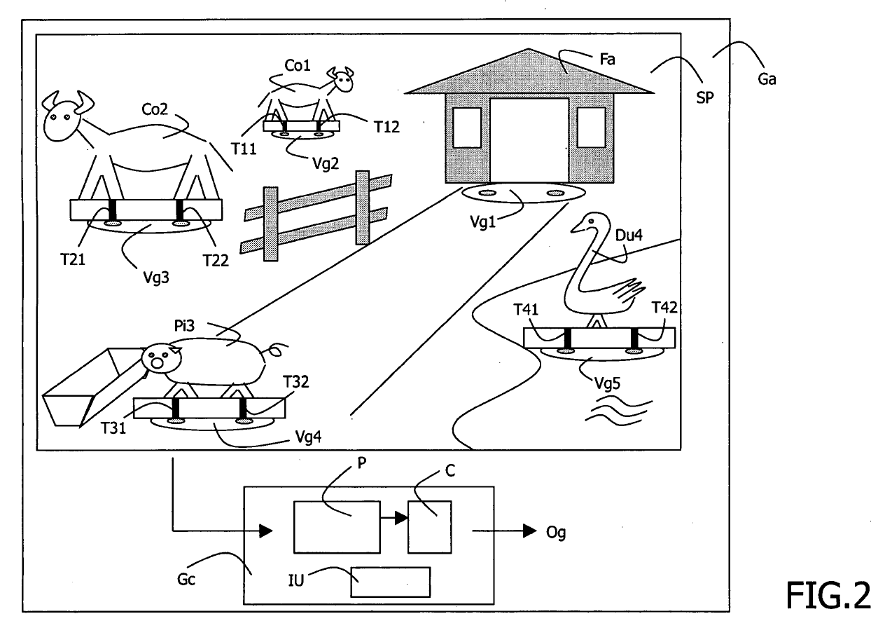

FIG. 2 shows an implementation of the system when applied to a game Ga. The game comprises a first object Co1 with two field generators T11, T12, a second object Co2 with two field generators T21, T22, a third object Pi3 with two field generators T31, T32, and a fourth object Du4 with two field generators T41, T42. The game further comprises a sensing plane Sp having several sensing surfaces Vg1, Vg2, Vg3, Vg4, Vg5. Each sensing surface comprises a set of two field sensors which can supply sensed signals to a processor P, for example, through a multiplexer or to a plurality of inputs of the processor P (not shown). The processor P generates two processor signals from the received sensed signals and divides one of the two processor signals by the second of the two processor signals as described hereinbefore. The output of the processor P is compared at the comparator C with at least one predetermined value (not shown) as described with reference to FIGS. 1A to 1G. The processor P and the comparator C are both part of a game-control unit Gc which controls the course of the game. The game-control unit Gc further comprises indicating circuitry IU to indicate from which sensing surface the object is identified.

The game displayed in FIG. 2 represents a story-telling game Ga. The sensing plane Sp represents a farm. At the sensing plane Sp, several locations are predefined, each location comprising a sensing surface Vg1, Vg2, Vg3, Vg4, Vg5. A first location comprises a first game sensing surface Vg1, a second location comprises a second game sensing surface Vg2, a third location comprises a third game sensing surface Vg3, a fourth location comprises a fourth game sensing surface Vg4, and a fifth location comprises a fifth game sensing surface Vg5. When an object, for example, the first object Co1 is placed at the second location, the second game sensing surface supplies a set of sensed signals to the processor P which generates an output signal corresponding to the first object Co1. Comparison of this output signal with the predetermined value Cv (not shown) enables the game-control unit Gc to recognize the first object Co1 and respond in a predetermined manner. In addition, the game-control unit Gc may have arrangements for identifying at which sensing surface Vg1, Vg2, Vg3, Vg4, Vg5 the first object Co1 is placed and may use this additional information in the predetermined response. In an embodiment of the game, each object Co1, Co2, Pi3, Du4 comprises a front field generator T12, T21, T31, T41 and a back field generator T11, T22, T32, T42. Within each object, the orientation of, for example, the magnetic field of the front field generators T12, T21, T31, T41 always points away from the sensing surface, and the orientation of the back field generators T11, T22, T32, T42 always points towards the sensing surface. When the game-control unit Gc can sense the orientation of the individual sensed signals, the game Ga is able to determine whether an object has its back field generator pointed to one side of the sensing plane SP.

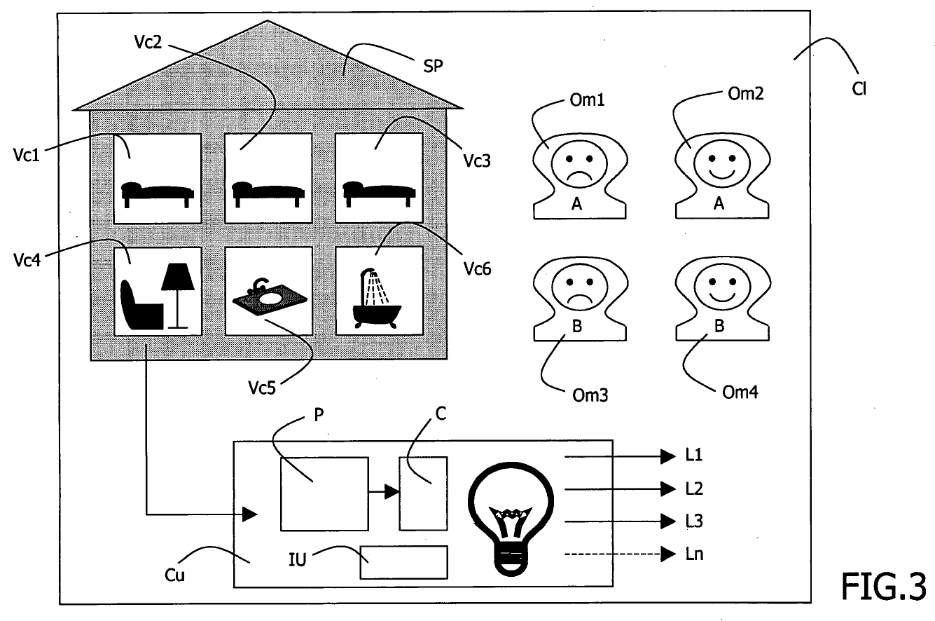

FIG. 3 shows an implementation of the system when applied to a control device for lighting control Cl. The sensing plane SP in the shown lighting control Cl comprises six sensing surfaces, Vc1, Vc2, Vc3, Vc4, Vc5, Vc6, representing a location within a house. The objects Om1, Om2 represent user A and the objects Om3, Om4 represent user B. The different objects may indicate, for example, the current mood of the specific user. The lighting control further comprises a control unit Cu having a processor P, a comparator C and an indicating unit IU as described hereinbefore. The output of the control unit Cu is connected to the light bulbs L1 to L4 throughout the house. A user A can place the object representing his mood Om1, Om2 at one of the sensing surfaces Vc1, Vc2, Vc3, Vc4, Vc5, Vc6 of the sensing plane SP which activates the lights at the selected location within the house. When the user has programmed a specific setting of the lights at the selected location which corresponds to the used mood object, the control unit will recognize the object representing the mood Om1, Om2 of user A and applies the predetermined setting at the selected location within the house.

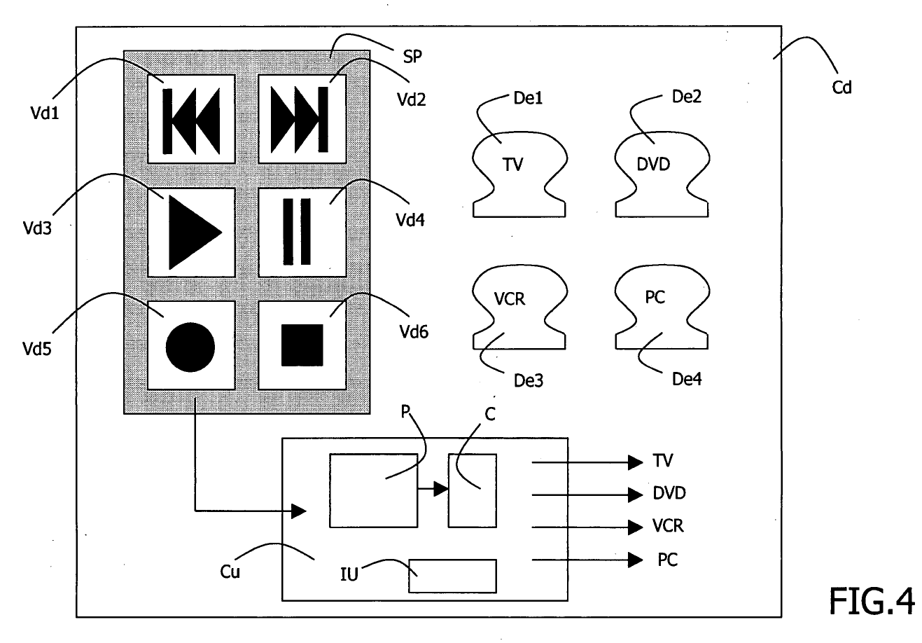

FIG. 4 shows an implementation of the system when applied to a consumer electronics system Cd. The sensing plane SP in the consumer electronics system Cd comprises six sensing surfaces, Vd1, Vd2, Vd3, Vd4, Vd5, Vd6 representing actions of an electronic device. For example, the third sensing surface Vd3 represents a play function of an electronic device and the sixth sensing surface Vd6 represents a stop function of an electronic device. The consumer electronics system further comprises four objects De1, De2, De3, De4, each object representing a different electronic device, for example, the first object De1 represents a television and the fourth object De4 represents a personal computer. The consumer electronics system further comprises a processor P, a comparator C and an indicating unit IU as described with reference to the other Figures. A user desiring to activate a specific electronic device, for example, the DVD player, places the second object De2 at the third sensing surface Vd3, indicating that the play function at the DVD player must be activated. The control unit Cu of the consumer electronics system Cd recognizes the second object De2 at the third sensing surface Vd3 and sends the appropriate signals to the appropriate electronic device. When, at the same time, for example, the VCR should record the signal coming from the DVD player, the user just needs to place the third object De3 representing the VCR at the fifth sensing surface Vd5, indicating that the VCR should record. The controlling unit Cu of the consumer electronics system Cd now also recognizes the third object De3 at the fifth sensing surface Vd5 and sends the appropriate signals to the appropriate electronic devices.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system (Sy) comprising an object (O1) and a sensing unit (SU) for identifying the object (O1), wherein
the object (O1) comprises a generator (T1, T2) for generating first and second fields (F1, F2), a ratio of whose respective strengths has a predetermined value;
the sensing unit (SU) is operative to identify the object (O1) on the basis of the predetermined value.

2. A system (Sy) as claimed in claim 1, wherein the sensing unit (SU) comprises a first field sensor (S1) for sensing a first field and a second field sensor (S2) for sensing a second field, and is operative to determine an identifier of an object (O1, O2) on the basis of the ratio between the first sensed field and the second sensed field.

3. A system (Sy) as claimed in claim 2, wherein the sensing unit (SU) comprises
a sensing plane (SP) comprising a sensing surface (V, Vg1) having a plurality of field sensors (S1, S2) for supplying a plurality of sensed signals (As1, As2) each being representative of a sensed field at a respective location of each one of the plurality of field sensors (S1, S2),
a processor (P) for receiving the sensed signals (As1, As2) to determine a first processor signal (Ap1) being dependent on at least one of the sensed signals (As1; As2) and a second processor signal (Ap2) being dependent on at least another one of the sensed signals (As1; As2) and for dividing the first processor signal (Ap1) and the second processor signal (Ap2) to obtain an output signal (Op1), wherein the first processor signal (Ap1) and the second processor signal (Ap2) are selected to vary with the same power of a distance (d) between the object (O1; O2) and the field sensors (S1, S2) when the position of the object (O1; O2) is changed with respect to the sensing surface (V) for changing said distance (d), and
a comparator (C) for comparing the output signal (Op1) with a predetermined value (Cv) to supply an identification signal (Iy, In) identifying the object (O1; O2).

4. A system (Sy) as claimed in claim 2, wherein the sensing unit (SU) further comprises a third field sensor (S0) for sensing a third field, and is further operative to correct the ratio between the first sensed field and the second sensed field on the basis of the third sensed field.

5. A system (Sy) as claimed in claim 1, comprising further sensing units (SU) in a predetermined spatial arrangement, each respective one of the units (SU) being operative to identify the object (O1) on the basis of the predetermined value.

6. A system (Sy) as claimed in claim 1, comprising a further object (O2), the further object (O2) comprising a further generator (T3, T4) for generating a further first field (F3) and a further second field (F4), a ratio of whose respective further strengths has a further predetermined value, the predetermined value and the further predetermined value being different from one another.

7. A system (Sy) as claimed in claim 1, wherein the object (O1, O2) comprises means for altering a field strength or orientation of at least one of the generated fields (F1, F2).

8. A system (Sy) as claimed in claim 1, wherein the generator (T1, T2) is arranged to generate magnetic fields.

9. An object (O1) for use in the system (Sy) of claim 1.

10. A set of objects (O1, O2) comprising an object (O1) and a further object (O2) for use in the system (Sy) of claim 6.

11. A sensing unit (SU) for use in the system (Sy) of claim 1.

12. A control device (Cl, Cd) comprising the system of claim 1 and further comprising a control unit (Cu) operative to receive an identifier identifying the object from the sensing unit (SU) and to control an electronic device (L1, L2, L3, Ln, TV, DVD, VCR, PC) in response to the identifier.

13. An electronic device (L1, L2, L3, Ln, TV, DVD, VCR, PC) comprising the control device of claim 12.
